(19) United States
(12) Patent Application Publication
(10) Pub. No.: US 2011/0115627 A1
(43) Pub. Date: May 19, 2011

(54) See ya alarm system

(76) Inventor: Larry Keith Smith, Crowley, LA (US)

(21) Appl. No.: 12/583,840

(22) Filed: Nov. 16, 2009

(51) Int. Cl. G08B 13/00

(52) U.S. Cl. 340/541

(57) ABSTRACT

A stand-alone motion sensing, lighting and alarming system for indoor use includes a box with mounting brackets and face plate, a motion sensor and alarm for receiving motion sensor and audible alarm electronics therein, a light holder pivotally mounted to the unit box, for receiving light therein. The unit box also includes an eight-foot cord and a grounded plug to establish electrical and mechanical connections with a source of 115 V.A.C. electrical power, a double pole single throw toggle switch for powering alarm, a double pole singe throw light switch for powering unit, and adjusters for the photocell and light/alarm duration.

### CROSS-REFERENCE TO RELATED APPLICATIONS

U.S. Pat. No. 5,867,099, issued on Feb. 2, 1999, to Daniel R. Keeter et al., describes an intruder alarm system having motion sensing and lighting systems, and more particularly, a motion sensing, lighting and alarm system that includes an audible alarm which operates in conjunction with, or independently from the lights. Keeter et al. do not suggest an indoor stand-alone non-permanent plug-in motion sensing, lighting and alarm system according to the claimed design invention.

U.S. Pat. No. 3,736,584, issued on May 29, 1973 to Kenneth R. Hackett et al., describes an intruder alarm system having a plurality of sound producing transducers designed to generate sound at a predetermined reference frequency. Hackett et al. do not suggest the motion sensing, lighting and alarm system according to the claimed design invention.

U.S. Pat. No. 3,913,066, issued on Oct. 14, 1975 to Manfred Kehry et al., describes an alarm system for motor vehicles that provides for the emission of intermittent acoustic and/or optical alarm signals by means of a pulse transmitter, adapted to be turned on by way of a push-button reachable from the driver seat and adapted to be turned off by way of a further push-button reachable only from the outside. Kehry et al. do not suggest the motion sensing, lighting and alarm system according to the claimed design invention.

U.S. Pat. No. 4,125,779, issued on Nov. 14, 1978 to William J. Malinowski, describes a smoke detector including a light-emitting diode and a photo-voltaic cell so arranged that the cell receives light from the diode reflected from smoke particles in ambient atmosphere, and circuit means for amplifying the cell output to provide an alarm output signal. Malinowski does not suggest the motion sensing, lighting and alarm system according to the claimed design invention.

U.S. Pat. No. 4,186,390, issued on Jan. 29, 1980 to Robert B. Enemark, describes a scatter type of smoke detector. Enemark does not suggest the motion sensing, lighting and alarm system according to the claimed design invention.

U.S. Pat. No. 5,243,327, issued on Sep. 7, 1993 to Allan J. Bentz et al., describes a small, compact motion detector alarm which emits an alarm sound when a low frequency vibration is detected. Bentz et al. do not suggest the motion sensing, lighting and alarm system according to the claimed design invention. U.S. Pat. No. 5,406,256, issued on Apr. 11, 1995 to Jeffrey W. Ledel et al., describes a motion detector which includes a motion-sensitive switch in series arrangement with a timing circuit, the timing circuit permitting activation of an encoder/transmitter circuit, which transmits a radio signal encoded according to the manual settings of encoder switches. A radio receiver receives the transmitted radio signal and develops corresponding signals into a decoder circuit which is selectively set with decoder switches to recognize only a predetermined sequence of input signals. A decoder output is connected to a latch circuit which in turn drives an audible or visible alarm. Ledel et al. do not suggest the motion sensing, lighting and alarm system according to the claimed design invention.

U.S. Pat. No. 5,463,595, issued on Oct. 31, 1995 to Arne Rodhall et al., describes a portable security system including a motion detector and an alarm which is activated upon sensing an intrusion within a monitored area. Rodhall et al. do not suggest the motion sensing, lighting and alarm system according to the claimed design invention.

None of the above inventions and patents, taken either singly or in combination, is seen to describe the present design invention as claimed.

### STATEMENT REGARDING FEDERALLY SPONSORED RESEARCH OR DEVELOPMENT

Not Applicable

### BACKGROUND OF THE INVENTION

The present invention is a motion sensing lighting and alarm system including an audible alarm, which operates in conjunction with, or independently from, the light, designed to use as an indoor stand-alone non-permanent plug-in unit.

Current indoor security systems are commonly hard-wired and geared toward home-owners. They also can be moderately expensive to install.

### BRIEF SUMMARY OF THE INVENTION

The present invention is a motion sensing, lighting and alarming system containing brackets to mount the unit to the wall and an eight-foot cord ending in a grounded plug for easy installation by plugging the unit into a 110-V outlet for establishing electrical and mechanical connections. The unit houses a motion sensor and audible alarm, such as a 120 V.A.C. extra loud continuous piezo sounder. The unit has a light holder pivotally mounted to the top of the unit for receiving light therein. The unit housing contains a double pole single throw toggle switch for powering alarm and a double pole singe throw light switch for powering unit.

The motion sensor contains a photocell, a sensitivity adjuster for the photocell, and a duration adjuster for the light/alarm. These features are located within the motion sensor front panel in the unit housing, which comes with a cover plate.

It is the object of the invention to provide a motion sensing, lighting and alarming system in which the light and audible alarm can operate in conjunction with or independently from each other.

It is the principal object of the invention to provide a stand-alone, non-permanent, easily installed, inexpensive and fully effective alarm system, which can be used by those who need a non-permanent, low-budget system, such as renters and college students.

### BRIEF DESCRIPTION FO THE SEVERAL VIEWS FO THE DRAWING

FIG. 1 is a front perspective view of the motion sensing, lighting and alarming system.

FIG. 2A is a view of the motion sensor indicating how to remove front panel in order to access adjusters.

FIG. 2B is a front view of the motion sensor with front panel removed.

FIG. 2C is a close up view of the motion sensor adjusters.

### DETAILED DESCRIPTION OF THE INVENTION

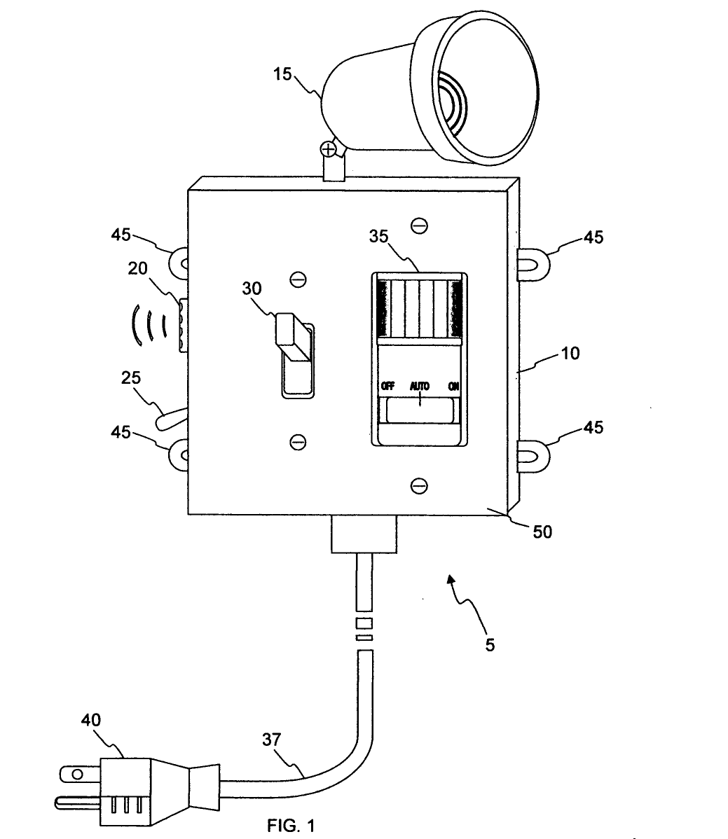

The present invention is a motion sensing, lighting and alarming system, indicated in FIG. 1. The unit is comprised of a box 10 which contains four mounting brackets 45 to mount the unit to the wall and an eight-foot cord 37 ending in a grounded plug 40 for easy installation by plugging the unit into a 110-V outlet for establishing electrical and mechanical connections. The unit box 10 houses a motion sensor 35 and audible alarm 20, such as a 120 V.A.C. extra loud continuous piezo sounder. The unit box 10 has a light holder 15 pivotally mounted to the top for receiving light therein. The unit box contains a double pole single throw toggle switch 25 for powering alarm 20 and a double pole singe throw light switch 30 for powering unit 5. The unit box 10 is covered with a face plate 50.

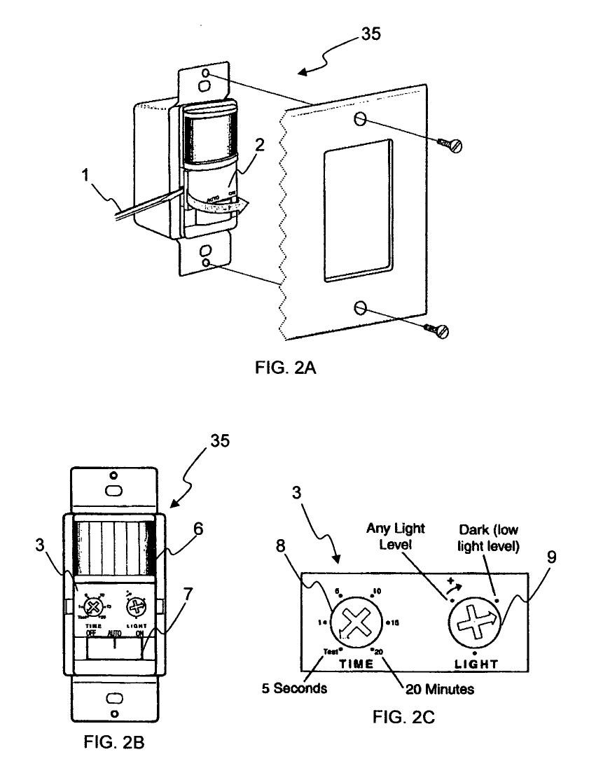

The motion sensor 35, indicated in FIG. 2A, contains a face plate 2, which can be removed by using a common flathead screwdriver 1. The motion sensor 35, better indicated in FIG. 2B, contains a photocell 6 and a panel 3 for adjusting sensitivity and duration. The motion sensor panel 3, better indicated in FIG. 2C, contains a sensitivity adjuster 9 for the photocell and a duration adjuster 8 for the light/alarm.

The light holder 15 works best with a 500-watt incandescent flood light, but any kind of non-fluorescent light with a 500-watt maximum may be used.

The motion sensor 35 has about a 150 degree arc and about a 15 to 30 foot range detection zone.

The motion sensing, lighting and alarming system 5 includes an internal electrical circuit arrangement which electrically interconnects the light holder 15 and the motion sensor 35 and an audible alarm 20 with an electrical power supply providing means, such as a source of 115 V.A.C. electrical power, so as to cause activating of the audible alarm 20 and/or the light holder 15 for a predetermined time in response to the motion sensor 35 sensing motion in a predetermined area monitored by the motion sensor 35.

The motion sensing, lighting and alarming system 5 can operate in one of two modes. The two modes include a light mode and a light/alarm mode. The user of the motion sensor utilizes the two position single pole toggle switch 25 to select the particular alarm mode desired. If the off mode is selected, then only the light in light holder 15 will respond to motion detected by motion sensor 35. If the on mode is selected, then both the light in light holder 15 and the audible alarm 20 will respond to motion detected by motion sensor 35.

Initially, the motion sensor adjusters are set with the duration switch 8 set in test position and the sensitivity adjuster 9 set in maximum position. Once the motion sensing, lighting and alarming system 5 is plugged in, the user tests the unit by setting the motion sensor switch 7 to auto. When the unit stabilizes (about 30 seconds to 1 minute) the sensor is ready to detect motion. If motion is detected, the lights will turn on. The lights will turn off 5 seconds after motion is no longer detected.

The sensitivity adjuster 9 is used to adjust the photocell to ensure the light in the room is at the level to turn the light/alarm on.

The duration adjuster 8 has six preset selections for the amount of time the light/alarm stays on: Test (5 seconds), 1, 5, 10, 15, and 20 minutes. A small Phillips screw driver can be used to adjust the desired time position.

I claim:

1. A motion sensing, lighting and alarming system comprised of a unit box with face plate and mounting brackets,
an audible alarm,
a motion sensor for sensing motion in a predetermined area,
a photocell,
a sensitivity adjuster for said photocell,
a two position single pole switch for activating unit,
a light holder,
a duration adjuster for said light holder and audible alarm,
and a two position single pole toggle switch which includes an off (light only) position and an on (light and alarm) position,
and a means for establishing electrical and mechanical connections between a source of 115 V.A.C. electrical power to said system.
